(19) United States
(12) Patent Application Publication
(10) Pub. No.: US 2013/0118992 A1
(43) Pub. Date: May 16, 2013

(54) Water Filtration and Purification System and Method

(71) Applicant: Yitzhak Isaac Henig, Ann Arbor, MI (US)

(72) Inventor: Yitzhak Isaac Henig, Ann Arbor, MI (US)

(21) Appl. No.: 13/670,650

(22) Filed: Nov. 7, 2012

Related U.S. Application Data
(60) Provisional application No. 61/558,715, filed on Nov. 11, 2011.

(51) Int. Cl. C02F 1/32

(52) U.S. Cl. CPC C02F 1/325
USPC 210/744; 210/251; 210/123; 210/143

(57) ABSTRACT

A unitary water treatment system for filtering and purifying untreated water is disclosed that has a filtration compartment, a transfer compartment, and a purification compartment. The untreated water flows into the filtration compartment, then into the transfer compartment, and then into the purification compartment. A fill valve is provided at the inlet of the water treatment system; a transfer valve is provided between the transfer and purification compartments; and a drain valve is provide at the exit of the purification compartment. A UV lamp is placed in the center of the purification compartment to expose water trapped in the purification compartment to light in a desired frequency range to kill bacteria and viruses.

### CROSS-REFERENCE TO RELATED APPLICATIONS

The present application claims priority benefit from U.S. provisional patent application 61/558,715 filed 11 Nov. 2011.

### FIELD

The present disclosure relates to a system and method for processing untreated water.

### BACKGROUND

A system and method by water can be both filtered and purified in a single unit is desired.

### SUMMARY

A unitary water treatment system for filtering and purifying untreated water is disclosed that has a filtration compartment, a transfer compartment, and a purification compartment. The untreated water flows into the filtration compartment, then into the transfer compartment, and then into the purification compartment. A fill valve is provided at the inlet of the water treatment system; a transfer valve is provided between the transfer and purification compartments; and a drain valve is provide at the exit of the purification compartment. A UV lamp is placed in the center of the purification compartment to expose water trapped in the purification compartment to light in a desired frequency range that kills bacteria and viruses. An opacity meter is provided in the top end of the filtration compartment. In some embodiments, an opacity meter is also provided at the bottom end of the filtration compartment.

An electronic control unit is coupled to electronically controlled valves and opacity sensors. Based on input from the sensors and/or other information, electronically controlled valves can be controlled.

Also disclosed is a method to control the water treatment system. A pressurized water supply is coupled to the inlet to the water treatment system. Untreated water flows into the filtration compartment that has a filtration media disposed therein. If the fill valve at the inlet of the filtration compartment is a float valve, the valve opens when the level of water in the filtration compartment is less than the set level. When the level hits the set level, the float valve closes. If the fill valve is electrically or mechanically actuated, the valve is opened to allow untreated water to flow into the filtration compartment. During this filling time, the transfer valve is closed. A self test of the opacity sensors may be performed when the filtration compartment is empty. If a fault is determined in either sensor, a fault code is set and operation of the system is discontinued.

By opening the transfer valve, water flows into the purification compartment. By evaluating the opacity sensor signal, the time at which the sensor is covered with water can be determined so that the transfer valve can be commanded to close. The level of the opacity sensor signal is used to determine how long that UV lamp should be operated to properly kill bacteria and viruses in the water. After the UV lamp has been operated for this period of time, the lamp is turned off and the drain valve is opened to allow the treated water to drain out. A signal from the opacity sensor at the bottom of the purification compartment can be used to determine when the treated water has been emptied. The batch process may be repeated to obtain the desired amount of purified water.

### BRIEF DESCRIPTION OF THE DRAWINGS

FIG. 1 is a schematic representation of a water filtration and purification system according to an embodiment of the disclosure;

FIG. 2 is a cross section of the representation of the embodiment in FIG. 1; and

FIG. 3 is a flowchart of a method to operate the system of FIGS. 1 and 2.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

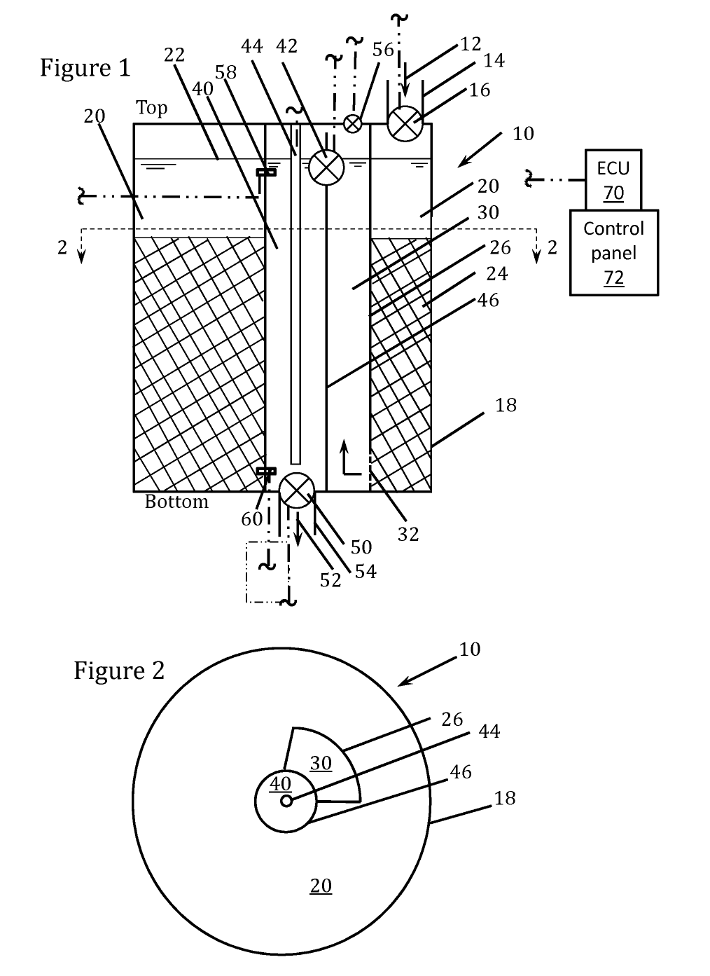

A water treatment system 10 is shown in FIG. 1 in cross section. System 10 is provided untreated water 12 at entrance 14 in which a fill valve 16 is disposed leading to a filtration compartment 20, which extends around the periphery of system 10. Compartment 20 is enclosed by outer wall 18. Fill valve 16 can be an electrically-operated valve such as a solenoid valve, a float valve which opens and closes based on the level of fluid in the compartment 20, or a manually operated valve. Untreated water (level of water is shown at 22) is contained in compartment 20 as well as filtration media 24. A wall 26 separates filtration compartment 20 from a transfer compartment 30 An opening in wall 26 near the bottom of system 10 has a screen 32 to contain filtration media 24 within compartment 20. Transfer compartment 30 is separated from purification compartment 40 by a wall 46. Wall 46 has an orifice into which a transfer valve 42 is disposed so that the transfer compartment 30 and purification compartment 40 can be selectively fluidly coupled. Purification compartment 40 has a UV lamp 44 centrally located. A reflective coating is provided on the inside surface of wall 46 so that UV light from UV lamp 44 is most effectively used. Also included is an orifice in the bottom of system 10 into which a drain valve 50 is disposed. When valve 50 is open, water 52 exits through exit tube 54. A vent 56 is fluidly coupled to transfer compartment 30 so that when transfer compartment 30 or filtration compartment 20 are empty, air exits vent 56 to allow water to be admitted into compartments 20 and 30. In the embodiment shown in FIG. 1, there is a gap in the wall near the top of system 10 between transfer compartment 30 and purification compartment 40. In such an embodiment, vent valve 56 allows air to be removed and air to be introduced into purification compartment 40 such as when purified water is drained out of compartment 40. If there is no such gap in wall 46, an additional vent may be provided at the top of purification compartment 40.

A cross section that is perpendicular to the view shown in FIG. 1 is illustrated in FIG. 2. The relative volumes of compartments 20, 30, and 40 as implied by the area ratios in FIG. 2 are just one example and are non-limiting to the present disclosure. Furthermore, the shapes of the compartments can be other than that shown in FIG. 2. It may be desirable, however, to have purification compartment 40 be of cylindrical shape with a cylindrical UV light 44 located centrally. With such a configuration, the path of the light is substantially constant from the source to the farthest reaches of the purification compartment.

Referring again to FIG. 1, an electronic control unit (ECU) 70 is provided. An opacity sensor 58 is provided in a wall of the purification compartment 40. The sensor has both a light source and a light sensor that causes the light from the light source reflects to the light sensor. The inside wall of purification compartment 40 has a reflective coating. The signal from light sensor provides an indication of the opacity of the medium in purification compartment 40. The signal from opacity sensor 58 is highest when there purification compartment 40 is empty. Thus, opacity sensor 58 can be used to detect when water is in purification compartment 40 up to the level of sensor 58. Sensor 58 is shown in FIG. 1 as being below the water level 22 and as pointing toward transfer valve 42. This is simply for illustration convenience. Instead, sensor 58 is placed at the desired fill level 22. Furthermore, sensor 58 is placed such that is not in a line of sight with transfer valve 42 for two reasons: to avoid the incoming water during the filling process confounding the determination of compartment 40 being filled. In the embodiment in FIG. 1, an opacity sensor 60 is also provided near the bottom of purification compartment 40 to provide an indication that the tank is emptied. In an alternative, the time that is takes to empty purification compartment is determined and closing of drain valve 50 and repeating of the purification cycle is delayed until at least the time to empty the purification compartment has elapsed.

As described above, valves 16, 42, and 54 are mechanically actuated. Alternatively, they are controlled via ECU 70. The dash-dot-dot lines in FIG. 1 indicate an electrical connection between ECU 70 and the various sensors and actuators that are part of the system.

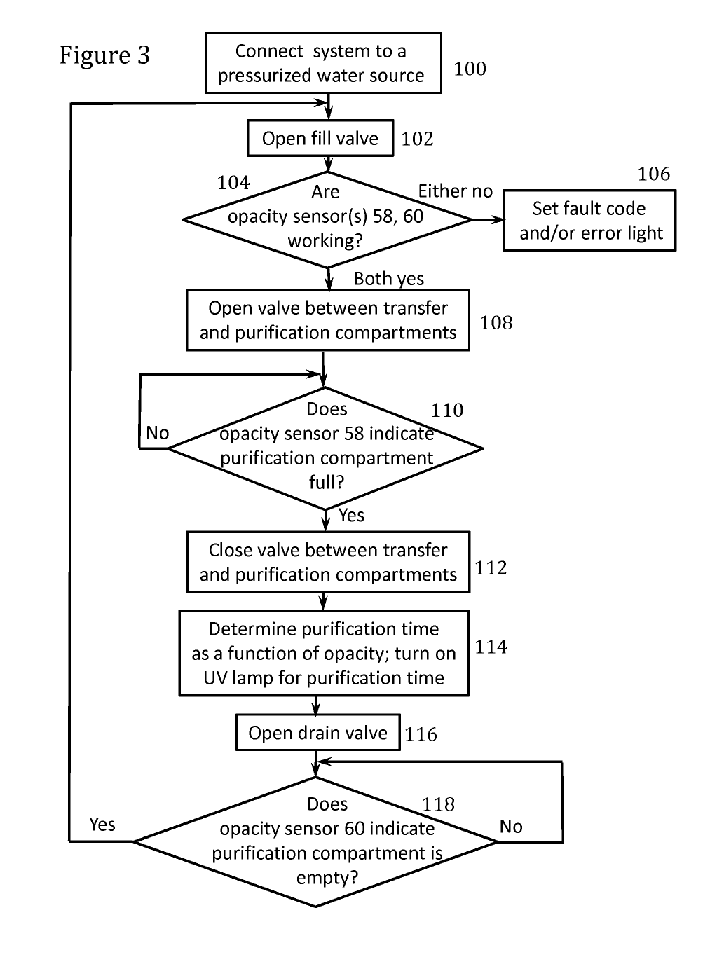

A method by which system 10 can be controlled is illustrated in a flowchart in FIG. 3. The description below starts with system 10 empty, except for having filtration media in filtration compartment 20. Further, valves 42 and 50 are closed. A pressurized water supply is connected to system 10 in block 100. The pressurized water supply can be due to a pump from a water reservoir or gravity feed from a water reservoir that is located above system 10. In block 102, fill valve 16 is automatically open when fill valve 16 is a float valve. Alternatively, fill valve 16 is opened manually by an operator. In yet another alternative, fill valve 16 is commanded to open under control of ECU 70. ECU 70 may be acting under control of an operator through control panel 72. That is, when the pressurized water supply is provided to inlet 14, the operator may depress a button on control panel 72 indicating that fill valve 16 should be opened. Or in another alternative, if there is a pressure sensor (not shown) on inlet 12, ECU 70 may command opening of fill valve 16 based on a signal from the pressure sensor. When fill valve 16 is open, water enters through inlet 12 and fills filtration compartment 20 and transfer compartment 30. Water is shutoff by closing fill valve 16 or by a float associated with fill valve 16.

Control passes to block 104 in which opacity sensors 58 and 60 are tested. If two such sensors are provided, as shown in FIG. 1, both sensors need to be working to pass control to block 108. If either of sensors 58 or 60 fail a self test, control passes to block 106 in which the system is stopped and a fault code is set in ECU 70. An error light on control panel 72 may be set to indicate the problem to the operator. When control passes to block 108, transfer valve 42 is opened, either manually by an operator or under control by ECU 70. Filtered water flows into purification compartment 40. The signal from opacity sensor 58 changes when the air that is in purification compartment 40 is displaced by water. In block 110, the change in signal is evaluated. When the signal changes, purification compartment 40 is full and control passes to block 112 in which transfer valve 112 is closed.

In block 114, a signal from opacity sensor 58 or 60 is used to determine opacity of the filtered water in purification compartment 40. Time that is required for purification is determined based on the opacity of the water in purification compartment 40. The UV lamp is turned on and operated for that purification time. Control then passes to block 116 in which drain valve 50 is opened and the purified water is released through exit tube 54.

Control passes to block 118 in which it is determined whether purification compartment 40 is empty. If not, control passes back to block 118. If so, control passes back to block 102. In one embodiment, exit tube 54 is coupled to a reservoir. If the reservoir becomes full, purification compartment 40 does not empty and the process is interrupted. In some embodiments, control panel 72 has a interrupt button to allow an operator to discontinue the operation of system 10.

In some embodiments, a light receptor on opacity sensor 58 or 60 may be used to detect the quality of light from UV lamp 44. That is, UV lamp 44 is turned on briefly while purification compartment is empty. UV lamp intensity degrades over time. In such embodiments, the purification time is further based on the intensity of the light from UV lamp 44. When UV lamp 44 intensity is too low to purify the water, a fault code in ECU 70 is set and possibly an error light is illuminated on control panel 72.

The filtration materials may be one of the following: sand, pure activated charcoal, silver-impregnanted activated charcoal, zeolite, bronze powder, aquarium wool, and coconut fibers, or a combination thereof. Such things as sand or coconut fibers might be readily available in some location in which purchased materials, such as activated charcoal, are not readily available.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

I claim:

1. A water treatment system, comprising:
a unitary enclosure having a plurality of compartments:
a filtration compartment comprising a majority of the volume of the enclosure into which filtration media is disposed;
a transfer compartment;
a cylindrical purification compartment; and
a UV lamp located substantially on a central axis of the purification compartment.

2. The system of claim 1 wherein the filtration media comprises at least one of: sand, pure activated charcoal, silver-impregnanted activated charcoal, zeolite, bronze powder, aquarium wool, and coconut fibers.

3. The system of claim 1 wherein the purification compartment is coated with a reflective material.

4. The system of claim 1, further comprising: a fill valve at an inlet of the filtration compartment.

5. The system of claim 4 wherein the fill valve is one of a mechanical float valve, a hand-operated valve, and an electrically-controlled valve.

6. The system of claim 1, further comprising:
a wall between the transfer compartment and the filtration compartment;
an orifice defined in the wall and located near a top end of the system; and
a transfer valve disposed in the orifice so that the transfer compartment is selectively fluidly coupled with the filtration compartment.

7. The system of claim 1, further comprising:
a wall between the transfer compartment and the filtration compartment;
an opening between the transfer compartment and the filtration compartment near the bottom of the system; and
a screen disposed in the opening.

8. The system of claim 1, further comprising: a drain valve fluidly coupled to the filtration compartment with the drain valve coupled near a lowest point of the filtration compartment.

9. The system of claim 8 wherein the valve is one of an electrically-controlled valve and a hand operated valve.

10. The system of claim 1, further comprising: an air vent disposed in the outer surface of the water treatment system proximate a top of the water treatment system.

11. The system of claim 6, further comprising:
an opacity sensor disposed in the filtration compartment near a top end of the filtration compartment; and
an electronic control unit (ECU) electronically coupled to the transfer valve and the opacity sensor wherein based on a signal from the opacity sensor, the ECU determines whether the filtration compartment is full, the ECU commands the transfer valve to open when the filtration compartment is less than full, and the ECU commands the transfer valve to close when the filtration compartment is full.

12. A method to control a water treatment system, comprising:
connecting an inlet of the water treatment system to a pressurized water source wherein the water treatment system includes: an enclosure having: a filtration compartment into which filtration media is disposed; a transfer compartment; a cylindrical purification compartment; a transfer valve disposed in a wall between the transfer and cylindrical purification compartments; and a UV lamp located substantially on a central axis of the purification compartment; and
commanding the transfer valve to open;
commanding the transfer valve to close in response to determining that the purification compartment has been substantially filled;
commanding the UV lamp to turn on when the purification compartment is filled;
determining that the water has been exposed to light from the UV lamp for a sufficient time; and
opening a drain valve disposed in the bottom of the purification compartment in response to the determination that water has been exposed to sufficient UV light.

13. The method of claim 12 wherein the determination the that purification compartment has been substantially filled is based on a signal from an opacity sensor disposed in the purification compartment.

14. The method of claim 12 wherein the sufficient time for exposing the water to UV light is based on a signal from an opacity sensor disposed in the purification compartment at a time immediately after the time that it is determined that the purification compartment is full.

15. The method of claim 12 wherein the sufficient time for exposing the water to UV light is at least partially based on an intensity of the UV lamp.

16. The method of claim 12 wherein the purification compartment further includes at least one opacity sensor disposed therein, the method further comprising:
performing a self test on the at least one opacity sensor when the purification compartment is substantially empty; and
indicating a fault to an operator of the water treatment system when the self test indicates a fault in the opacity sensor.

17. The method of claim 12, further comprising:
detecting when the purification compartment is empty based on a signal from an opacity sensor disposed in the purification compartment proximate a bottom end of the purification compartment.

18. A water treatment system, comprising:
an enclosure having a plurality of compartments:
a filtration compartment comprising a majority of the volume of the enclosure into which filtration media is disposed;
a transfer compartment with an orifice disposed in a wall between the filtration compartment and the transfer compartment and a screen disposed in the orifice;
a cylindrical purification compartment;
a transfer valve disposed in a wall between the transfer compartment and the purification compartment;
a drain valve disposed in the purification compartment proximate a bottom end of the purification compartment; and
a UV lamp located substantially on a central axis of the purification compartment.

19. The water treatment system of claim 18, further comprising: a float valve at an inlet to the filtration compartment.

20. The water treatment system of claim 18, further comprising: an air vent disposed in a top side of the water treatment system.
